(19) United States
(12) Patent Application Publication
(10) Pub. No.: US 2004/0180129 A1
(43) Pub. Date: Sep. 16, 2004

(54) Method of reducing acrylamide levels in food products and food intermediates and products and intermediates produced thereby

(76) Inventors: David W. Plank, Taylors Falls, MN (US); Gayle L. Crose, Minneapolis, MN (US); Douglas J. Novak, Big Lake, MN (US)

Correspondence Address: GENERAL MILLS, INC., P.O. BOX 1113, MINNEAPOLIS, MN, 55440, US

(21) Appl. No.: 10/386,244

(22) Filed: Mar. 11, 2003

(51) Int. Cl. A23L 1/216

(52) U.S. Cl. 426/637

(57) ABSTRACT

The present invention relates to novel uses of cyclodextrins, to reduce acrylamide levels in food products and food intermediates after the food product or food intermediate has been cooked or otherwise treated to make it suitable for human or animal consumption, as well as to enhance the hypocholesterolemic benefit either individually or synergistically with other components.

### CROSS-REFERENCES TO RELATED APPLICATIONS

None.

### FIELD OF THE INVENTION

The present invention relates to a method for reducing acrylamide levels in food products and food intermediates that are intended for human and animal consumption as well as the food products and food intermediates produced thereby. More specifically, the present invention is directed to the use of alpha-cyclodextrin, beta-cyclodextrin, gamma-cyclodextrin, combinations and modified derivatives thereof in the preparation of food products and food intermediates to lower acrylamide levels. In addition, the food product and food intermediates of the present invention containing such cyclodextrin compounds provide beneficial hypocholesterolemic activity through increased bile acid and lipid binding activity. The invention is also directed to communicating the benefit of the particular food product.

### BACKGROUND OF THE INVENTION

Acrylamides have been classified as a potential carcinogen and neurotoxin that has been recently discovered to exist in varying levels in processed foods, such as fried, baked and cooked foods that are made from grain and vegetable based products such as potatoes. It has been proposed that acrylamide is formed as a result of the Maillard reaction between amino acids and reducing sugars. Asparagine, a major amino acid found in cereals (grains) and potatoes is thought to be the significant player in acrylamide production.

The Mailard reaction is responsible for producing much of the color and flavor in processed foods, such as those produced during the typical heating, cooking, frying, baking or roasting steps that accompany the production of breads, cereals, potato snacks, pastries, etc.

Asparagine has an amide group attached to a chain of two carbon atoms. The degradation of the amino acids in the presence of dicarbonyl products from the Mailard reaction causes the amino acid to become decarboxylated and deaminated to create an aldehyde. When glucose and asparagines are reacted at elevated temperatures, particularly those above 100° C., more typically above 120° C. and usually above 185° C. significant levels of acrylamides may be produced.

A significant health concern for humans is cholesterol levels. Cholesterol in humans is known to come from primarily two sources, the body's own production of cholesterol (endogenous) and dietary cholesterol (exogenous). Lipoproteins contain specific proteins and varying amounts of cholesterol, triglycerides and phospholipids.

Bile acids are synthesized from cholesterol in the liver and then secreted into the intestines. Reducing the level of bile acid reabsorption facilitates the maintenance of a healthy cholesterol level. One method for reducing bile acid reabsorption is achieved by increasing the gut viscosity. Alternatively, a non-digestible dietary component, which binds bile acids secreted in the proximal jejunum, will reduce bile acid reabsorption in the lower intestines (distal ileum). Additionally, a non-digestible dietary component, which binds lipids (e.g. phoshatidyl choline) may disrupt micelles in the small intestine thereby reducing cholesterol and bile acid uptake. The fermentation of this non-digestible dietary component in the cecum may also play a role in lowering cholesterol levels through the production of short-chain fatty acids and through the acidification of the cecum.

There are three major classes of lipoproteins and they include very low-density lipoproteins (“VLDL”), low-density lipoproteins (“LDL”) and high-density lipoproteins (“HDL”). The LDLs are believed to carry about 60-70% of the serum cholesterol present in an average adult. The HDLs carry around 20-30% of serum cholesterol with the VLDL having around 1-10% of the cholesterol in the serum. To calculate the level of non-HDL cholesterol present (find the level of LDL or VLDL levels), which indicates risk; the HDL is subtracted from the total cholesterol value.

A focus of the present invention relates to novel uses of cyclodextrins, to reduce acrylamide levels in food products and food intermediates, as well as to enhance the hypocholesterolemic benefit either individually or synergistically with other components.

Cyclodextrins comprise a doughnut shaped or cyclical structure composed of between six to eight alpha-D-glucose units having a hydrophilic exterior (hydrophilic OH groups on the exterior rim) and a hydrophobic interior (electron dense hydrogen and oxygen atoms). Cyclodextrins are generally water soluble, free flowing crystalline powders that are substantially if not completely odorless and white in color.

Cyclodextrins are produced by the action of cyclodextrin glucosyltransferase (CGTase, EC 2.4.1.19) on hydrolysed starch syrups at neutral pH (6.0-7.0) and moderate temperature (35-40° C.). Alternatively, cyclodextrins can be produced in planta by the expression of the gene encoding CGTase in the food plant of interest.

Heretofore, starches such as cyclodextrins have not been employed or known for their hypocholesterolemic activity in humans or for their beneficial reduction of acrylamide levels. Cyclodextrins have been used principally for the encapsulation of insoluble compounds on a molecular basis in order to enhance stability, reduce volatility and alter solubility as well as to increase shelf life of certain products. Such prior uses of cyclodextrins have been limited to flavor carriers and protection of sensitive substances against thermal decomposition, oxidation and degradation. In addition, more recently, cyclodextrins have also been used to remove fatty acids and cholesterol from animal fats and to remove cholesterol and cholesterol esters from egg yolks.

One potential solution to the high cholesterol problem teaches the treatment of the foodstuffs themselves with cyclodextrins rather than the consumer. U.S. Pat. Nos. 5,498,437, 5,342,633 and 5,063,077 discuss various processes for the removal of cholesterol and cholesterol esters from egg yolks, meat, animal fats, etc. It is thought that by reducing the level of cholesterol in such foodstuffs that overall levels of cholesterol may be reduced in consumers. However, processing steps to such foodstuffs increases the cost of delivering such products to market.

Another similar but apparently unrelated reference, which deals with removal of cholesterol from foodstuffs, is U.S. Pat. No. 5,232,725. This reference discusses a process for reducing cholesterol and free fatty acids in an animal fat and the material obtained from that process through the use of cyclodextrins. U.S. Pat. No. 5,223,295 also discusses the use of cyclodextrin to remove steroid based compounds from foodstuffs, particularly egg yolks. However, these patents suffer from the same drawbacks as those referenced above, in that the processing steps required to achieve the result adds another layer to delivering product to the market, causing delay and adding cost.

PCT Publications WO 99/59421 and WO 99/63841 disclose the use of phytosterols as a pharmaceutical agent or as an addition to certain foodstuffs for lowering cholesterol. The publication discusses that greater effectiveness of the phytosterols can be achieved when using a specified delivery vehicle such as a complexation with cyclodextrins. This represents little more than using cyclodextrins for a purpose that they are already known for, as a carrier for sensitive ingredients.

Another reference that teaches the use of beta-cyclodextrin as a carrier or delivery vehicle is U.S. Pat. No. 4,978,532. In this reference, dehydroepiandrosterone (DHEA) is delivered to the patient via a treatment patch. Beta-cyclodextrin is selected from a group of “permeation enhancers” to facilitate the delivery of the DHEA dose to the patient.

U.S. Pat. No. 5,624,940 the use of various complexes which include cyclodextrins for reducing bone loss and serum cholesterol levels in mammals. In this reference, the cyclodextrin, specifically hydroxypropyl-beta-cyclodextrin is used as a pharmaceutical delivery agent and not as an active ingredient useful in the reduction of serum cholesterol levels.

U.S. Pat. No. 4,877,778 discusses the administration of doses of 2-hydroxypropyl-beta-cyclodextrin at levels of up to 0.5 gm/kg per day. The cyclodextrin is used as a carrier to remove excess lipophiles from the system, specifically as set forth in the example, reduction of high vitamin A levels. With respect to serum cholesterol levels, the '778 patent suggests that the reduction of serum cholesterol levels achieved in the example is due to the system recognizing an overabundance of cholesterol and the serum cholesterol being subsequently “down-regulated. Such down-regulation is a known biologic phenomenon.” The '778 patent goes on to indicate that it is “the natural cholesterol carrying system which predominates and it is the new homeostasis which must be responsible for the observed drop in serum cholesterol.” Hence, the '778 patent does not suggest that the cyclodextrin is usable as a mechanism to bind bile acids or lipids to decrease reabsorption in the lower intestines and is merely cumulative of the prior art which illustrates the use of cyclodextrin as a particular pharmaceutical carrier to treat certain disorders.

Publications, patents and patent applications are referred to throughout this disclosure. All references cited herein are hereby incorporated by reference.

All percentages and ratios are calculated by weight unless otherwise indicated. All percentages and ratios are calculated based on the total composition unless otherwise stated.

### BRIEF SUMMARY OF THE INVENTION

Surprisingly, it has been found that through the addition of cyclodextrins (alpha, beta and/or gamma and/or combinations thereof) to a food product or food intermediate, the asparagine amino acid is sequestered in the hydrophobic binding pocket of the cyclodextrin and prevented from reacting with a reducing end. Alternatively, glucose or other small reducing sugars may be sequestered by the cyclodextrin preventing interaction with free asparagines. The result is lowered acrylamide levels in the product.

It has also been found that cyclodextrins incorporated into food products have beneficial hypocholesterolemic properties.

In one embodiment of the present invention, food product having reduced acrylamide levels after cooking, baking, frying, heating and combinations thereof is described and includes, a food product or food intermediate that has been derived from grain or vegetable based components or combinations thereof, and an amount of cyclodextrin ranging from 0.001% to 75% by weight of the food product or food intermediate.

In a still further embodiment of the present invention a vegetable or grain based food product or food intermediate having reduced acrylamide levels after baking, heating, cooking, frying and combinations thereof and containing between 0.01 to 75% by weight of a cyclodextrin.

In a further embodiment of the present invention, a method for producing a food product having a reduced acrylamide level after heating, cooking, baking, frying and combinations thereof, is described and includes the steps of initially providing one or more ingredients useful in forming a food product. Next, an amount of cyclodextrin is added to the one or more ingredients. The food product containing the amount of cyclodextrin is produced in a number of known processes and finally the food product is distributed.

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a graphical representation of the amount of cyclodextrin versus the acrylamide levels in an RTE cereal product.

### DETAILED DESCRIPTION OF THE INVENTION

The present invention is now illustrated in greater detail by way of the following detailed description, but it should be understood that the present invention is not to be construed as being limited thereto.

As used herein a food product and food intermediate may include an additive, component, supplement or ingredient useful in preparing or supplementing a food, or a food intermediate, a fully prepared composition but in a raw state (requiring a further treatment step prior to consumption, such as baking dough to produce bread) or a finished food product that is ready to eat. Food products and food intermediates as provided hereunder generally include any food products or food intermediates derived from or containing grain, cereal or vegetable based components. Food products may also include nutritional beverages and energy drinks.

As used herein a ready to eat food product includes baked goods, muffins, rolls, cakes, pies, crackers, toaster pastries, pastries, grain based bars, granola bars, health food bars, breads, cereals, fruit snacks, fruit bars, pizza rolls, soups, pasta, yogurt, pudding, beverages, sauces, snacks (potato crisps, French fries, corn chips, tortilla chips, extruded snacks, enrobed extruded snacks, pretzels), rice and corn cakes, fried and processed foods and generally any food products or food intermediates derived from or containing grain, cereal or vegetable based components.

As used herein, the terms cooking, heating, baking, frying include the use of microwave and radiant energy as well as warming, steaming, boiling, stewing and other steps generally imparted to food products and food intermediates to prepare them for human or animal consumption.

The term cereal as used herein refers to wheat, rice, corn, oats, barley, grain and the like.

The term intermediate as used herein relates to a food product that is in an intermediate step and requires further treatment such as by cooking in order to prepare the product for human or animal consumption. An example of a food intermediate is dough.

The term serving size as used herein varies depending on the product, for example with a ready to eat cereal such as CHEERIOS® available from General Mills, Inc. Minneapolis, Minn. 55426, the serving size may range from 15 to 65 grams, a dairy product such as yogurt may have a serving size of ranging from approximately 30 grams up to 230 grams, snack sizes may range from 30 grams to over a 100 grams.

Inclusion of cyclodextrins in ready to eat (RTE) cereals, mixes, doughs, grain or vegetable based foods and other food products in an amount between 0.01% to 75% by weight, preferably from 1 to 20% and more preferably from 2 to 8% by weight, can reduce the level of acrylamides present in such food products or food intermediates as well as can be used to increase the amount of bile acid binding activity occurring in the gut and thereby reduce total serum cholesterol levels.

Cyclodextrin is a product of enzymatic conversion or degradation of starch in which a cyclic ring of sugars is created containing between 5 to 1,000,000 glucose units and more typically between 6 to 8 glucose units. A principal source of cyclodextrins is maize starch. However, cyclodextrins may be derived from a wide variety of plant starches.

Cyclodextrins are produced by the action of cyclodextrin glucosyltransferase (CGTase, EC 2.4.1.19) on hydrolysed starch syrups at neutral pH (6.0-7.0) and moderate temperature (35-40° C.). Alternatively, cyclodextrins can be produced in planta by the expression of the gene encoding CGTase in the food plant of interest.

The present invention also relates to a food product in which the cyclodextrin is prepared either chemically or enzymatically from derivatives of alpha-cyclodextrin, beta-cyclodextrin, gamma-cyclodextrin and combinations thereof. In addition, the cyclodextrin used in the present invention may be formed in or on the food product by treatment with the enzyme, such as cyclodextrin glucosyltransferase (CGTase, EC 2.4.1.19) or a mutation or modification thereof.

Another means by which to include the cyclodextrin in the food product is through the expression of the gene encoding cyclodextrin glucosyltransferase (CGTase, EC 2.4.1.19) or a mutation or modification thereof, in the grain, cereal or vegetable itself.

While not wishing to be bound to any particular theory, it has been found that by processing a food product or food intermediate in the presence of cyclodextrins (alpha, beta and/or gamma), the asparagine is sequestered in the hydrophobic binding pocket of the cyclodextrin and prevented from reacting with a reducing end. Alternatively, glucose or other small reducing sugars may be sequestered by the cyclodextrin preventing interaction with free asparagine. The result is lowered acrylamide levels in the product as opposed to similar products that do not contain cyclodextrins.

Also as indicated above, the cyclodextrins with its hydrophobic core can bind cholesterol or bile acids and allow these molecules to be excreted from the system in the stool.

One method of preparing cyclodextrins includes enzymatic treatment. Enzymatic degradation or treatment of the starch to produce cyclodextrins useful in the present invention is done through the use of cyclodextrin glucosyltransferase (EC 2.4.1.19) or other enzymes, which results in a cyclic ring of sugar. The cyclodextrin is resistant to digestion but is susceptible to fermentation by bacteria in the cecum or foregut of the organism. The hydrophobic core serves as binding sites for amino acids such as asparagine, bile acids and steroids, namely cholesterol. The bond formed between the cyclodextrin and the amino acid asparagine, bile acids and cholesterol is sufficiently strong so as to enable the material to pass through the system without being reabsorbed through the intestines.

The preferred starch of the present invention are cyclodextrins, preferably alpha-cyclodextrins. As indicated previously, cyclodextrins comprise a doughnut shaped or cyclical structure composed of a number of alpha-D-glucose units (typically 6-8) having a hydrophilic exterior and a hydrophobic interior. Alpha-cyclodextrin is a cyclized ring of six alpha 1,4 linked glucose units.

Cyclodextrins are generally water soluble, although alpha-cyclodextrin is likely more water soluble than beta-cyclodextrin or gamma-cyclodextrin, and free flowing crystalline powers that are substantially if not completely odorless and white in color. Heretofore, modified starches such as cyclodextrin were not employed or known for their hypocholesterolemic or acrylamide reducing activity and have been used principally for the encapsulation of insoluble compounds to enhance stability, reduce volatility and alter solubility. Such prior uses of cyclodextrins have been limited to carriers for flavors, therapeutic agents and to remove fatty acids and cholesterol from animal fats.

Alpha-cyclodextrins has a cavity dimension of about 0.50×0.79 (nm) and a cavity volume of about 0.10 (ml). The solubility of alpha-cyclodextrin at 25° C. is 14 (gm/100 mil). Alpha-cyclodextrin is available from Wacker Specialties, Adrian, Mich. 49221 and sold under the trademark CAVAMAX® Wacker-Chemie, Burghausen, Germany.

Other cyclodextrins may be used in combination or synergistically with alpha-cyclodextrin, such as beta-cyclodextrin and gamma-cyclodextrin, in particular ratios dependent upon the requirements of the manufacturer. In an exemplary embodiment, alpha-cyclodextrin may be used individually or may be combined with between 0-10% by weight beta-cyclodextrin or gamma-cyclodextrin and more preferably between 0.1 to about 8% by weight.

The processing of ready to eat cereals or other food products is done by incubation of the food product with the enzyme, cyclodextrin glucosyltransferase (GCTase) (EC 2.4.19). GCTase is a member of the alpha-amylase family of enzymes. The enzyme is provided at between the levels of 0.00001 to 75.0% weight of the product. By incubating the food product or components of the food product during the processing with the enzyme, polysaccharides are converted into non-digestible, fermentable forms that increase the efficacy of the food product to lower the ingesting organisms cholesterol concentration as well as to limit acrylamide formation.

### EXAMPLE 1

In an exemplary embodiment of the present invention, the food product, in this case a ready to eat (RTE) cereal, may include the following micro and macronutrients in connection with an amount of alpha-cyclodextrin, beta-cyclodextrin, gamma-cyclodextrin and combinations thereof. In this example, samples were prepared using about 2 to 8% of each of alpha-cyclodextrin and beta-cyclodextrin by weight of the serving size of the product were prepared. The serving size ranges from 30 to 55 grams.

Recommended Daily Value (“DV”)

| | |
|---|---|
| Total Fat | 5% |
| Saturated Fat | 3% |
| Cholesterol | 0% |
| Sodium | 10% |
| Potassium | 5% |
| Total Carbohydrate | 14% |
| Dietary Fiber | 17% |
| Protein | 10% |
| Vitamin A | 10% |
| Vitamin C | 70% |
| Calcium | 10% |
| Iron | 45% |
| Vitamin D | 10% |
| Vitamin E | 100% |
| Thiamin | 100% |
| Riboflavin | 80% |
| Niacin | 80% |
| Vitamin B6 | 80% |
| Folic Acid | 100% |
| Vitamin B12 | 100% |
| Phosphorus | 15% |
| Magnesium | 10% |
| Zinc | 80% |
| Copper | 4% |

This example is based on a 2,000 calorie diet and other food products such as cereal bars, fruit snacks, dairy and bakery products, baking mixes and ready to eat meals may contain additional vitamins, nutrients and or minerals as well as potentially varying amounts of the macro and micro nutrients set forth in the instant example.

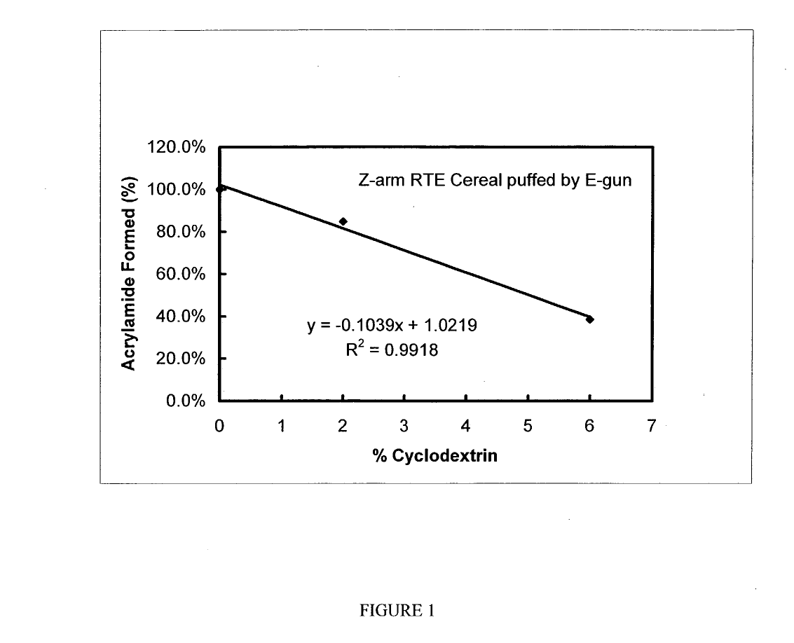

The samples prepared in connection with the above mentioned example were prepared from cereal grains, such as oat, wheat, corn, rice, etc. based RTE cereals and acrylamide levels in each of the samples were compared against a control sample produced according to the same method. The cereals had a 2% by weight beta-cyclodextrin and 6% beta-cyclodextrin by weight were used in the sampling with the following results. See also FIG. 1.

| Sample | Component | PPB Acrylamide |
|---|---|---|
| Oat Cereal | Control | 111 |
| Oat Cereal | 2% beta-cyclodextrin | 94 |
| Oat Cereal | 6% beta-cyclodextrin | 43 |

Acrylamide was measured in food products using the following methodology:

Reagents and Consumables

Acrylamide (Sigma Chemical Company, St. Louis, Mo.)

¹³C₃-labeled acrylamide (Cambridge Isotope Laboratory, Andover, Mass.)

HPLC grade acetonitrile (Omnisolv, EM Science, Gibbstown, N.J.)

HPLC grade methanol (Omnisolv, EM Science, Gibbstown, N.J.)

HPLC grade 2-propanol (Omnisolv, EM Science, Gibbstown, N.J.)

HPLC grade water (Omnisolv, EM Science, Gibbstown, N.J.)

Formic acid 99% (Sigma Chemical Company, St. Louis, Mo.)

Glacial acetic acid 99% (Sigma Chemical Company, St. Louis, Mo.)

Maxi-Spin filter tube, 0.45 μm PVDF (Alltech Associates, Deerfield, Ill.) 50 mL polypropylene conical tube with cap (Becton Dickinson)

Hydro-RP 80A HPLC column (2×250 mm), 4 micron packing (Phenomonex, Torrance, Calif.). Wash column a minimum of 20 min with 50:50 methanol:acetonitrile after 48 samples or at end of daily operations. Mobile phase re-equilibration for analyses will require 1.5 hr.

OASIS HLB 6 mL solid phase extraction cartridge, 200 milligram packing (Waters Corporation, Milford, Mass.).

Bond Elut—Accucat (mixed mode, C8, SAX and SCX) 3 mL solid phase extraction cartridge, 200 milligram packing (Varian Inc., Harbor City, Calif.).

Instrumentation

Agilent (Palo Alto, Calif.) Model 1100 autosampler, binary HPLC pump and column heater

Micromass Inc. (Manchester, UK), Quattro micro triple quadrupole mass spectrometer

Sample Preparation

1. Crush and homogenize a portion of sample equal to the manufacturer's recommended serving size with a food processor or equivalent device.

2. Weigh a one gram portion of crushed sample into a 50 mL polypropylene graduated conical tube with cap.

3. Add 1 mL of internal standard solution (¹³C₃-labeled acrylamide in 0.1% formic acid, 200 ng/mL), followed by 9 mL of water to the test portion. Shake by hand or vortex briefly to disperse test portion in water prior to step 4.

4. Mix for 20 minutes on a rotating shaker. (MN: Do not heat or sonicate, as this may generate an extract that will clog the SPE column.)

5. Centrifuge at 9000 rpm for 15 min. Promptly remove 5 mL portion of clarified aqueous phase for spin filtration and SPE. Avoid top oil layer and bottom solids layer when removing portion of aqueous phase.

6. Place 5 mL portion in Maxi-Spin filter tube, 0.45 μm PVDF (Alltech #2534). Centrifuge at 9000 rpm for 2-4 min. If filter clogs, insert new filter into tube, pour unfiltered liquid onto new filter and continue centrifugation until most of the liquid has passed through filter.

7. Condition OASIS SPE cartridge with 3.5 mL methanol, followed by 3.5 mL of water. Discard methanol and water portions used to prepare cartridge. A number of SPE cartridges were tested during development of this method, and all of them had different analyte retention and elution characteristics. Do not substitute another SPE sorbent in this step without testing.

8. Load OASIS SPE cartridge with 1.5 mL of the 5 mL test portion extract. Allow extract to pass completely through the sorbent material. Elute column with 0.5 water and discard. Elute column with additional 1.5 mL water and collect for Varian SPE cartridge cleanup. Do not use a vacuum to speed-up the elution process in any of the SPE steps.

9. Place mark on outside of Varian SPE cartridge at height of 1 mL liquid above sorbent bed. Condition Varian SPE cartridge with 2.5 mL methanol, followed by 2.5 ml of water. Discard methanol and water portions used to prepare cartridge. Load 1.5 mL portion collected in step 8 and elute to 1 mL mark before collecting remainder of eluted portion. Transfer to 2 mL auto-sampler vial for LC/MS/MS analysis. This step removes a number of early eluting co-extractives, resulting in better precision for sub-50 ppb measurements. Do not load more than 1.5 mL of extract onto Varian SPE cartridge.

Liquid Chromatography/Mass Spectrometry:

1. Mobile phase composition: Aqueous 0.1% acetic acid, 0.5% methanol

2. Column flow rate: 200 μL/min

3. Post-column makeup flow rate: 50 μL/min 1% acetic acid in 2-propanol

3. Injection volume: 20 μl

4. Column temperature: 26° C.

5. Acrylamide elution time: approximately 7.1 minutes

6. Ionization Mode: Positive ion electrospray

8. Probe temperature: 240° C.

9. Source temperature: 120° C.

10. Desolvation gas flow: 710 L/hr nitrogen

11. Cone Gas flow: 153 L/hr nitrogen

12. Collision gas pressure: 1 Torr argon

13. MRM ions: Acrylamide (m/z 72, 55, 27), Internal Standard (75, 58, 29). Collision energy of transitions for MRM: 72>72 and 75>75, 5 volts; 72>55 and 75>58, 10 volts; 72>27 and 75>29, 19 volts. Dwell time 0.3 sec each with 0.02 sec inter-channel and inter-scan delay.

14. Quantitation: Parts per billion acrylamide=(200 ng internal standard)(area of m/z 55)/(area of m/z 58)(g of portion analyzed)(response factor). The response factor is the average response factor obtained from a concurrently run standard curve encompassing the range of apparent acrylamide levels in the test portions. Limit of quantitation is defined as the level at which a 10:1 signal/noise ratio is observed for the analyte quantitation ion (m/z 55).

A further sample was prepared in accordance with the processes described herein using 2% by weight alpha-cyclodextrin and 4% by weight alpha-cyclodextrin and the following results were obtained.

| Sample | Component | PPB Acrylamide |
|---|---|---|
| Oat Cereal | Control | 111 |
| Oat Cereal | 2% alpha-cyclodextrin | 89 |
| Oat Cereal | 4% alpha-cyclodextrin | 47 |

The RTE cereals of the preceding example are prepared in a conventional manner, mixing the ingredients, except that a portion of the flour (oat, wheat) or conventional starch is replaced with alpha-cyclodextrin, beta-cyclodextrin, gamma cyclodextrin or combinations thereof. The ingredients are first processed with an enzyme, such as cyclodextrin glucosyltransferase, that produces a particular cyclodextrin, here in an exemplary embodiment, alpha-cyclodextrin, to produce a food intermediate, here a dough. This exemplary RTE cereal is created by preparing a cooked cereal dough through known methods and then forming the cooked cereal dough into pellets that have a desired moisture content. The pellets are then formed into wet flakes or shaped pieces by passing the pellets through chilled roller and then subsequently toasting or heating the wet cereal pieces. The toasting causes a final drying of the wet pieces, resulting in slightly expanded and crisp RTE cereal. The cereal pieces are then screened for size uniformity. The final cereal attributes of appearance, flavor, texture, inter alia, are all affected by the selection and practice of the steps employed in their methods of preparation. For example, to provide cereals having a desired appearance feature of grain bits appearing on the pieces, one approach is to topically apply the grain bits onto the surface of the pieces as part of a coating that is applied after toasting.

While the foregoing examples are directed to the manufacture of certain cereal types, it is readily apparent, that the manufacturing method can be modified to produce puffed or extruded cereals as well in which the dough after forming is either fed through an extruder to create the desired shape or in the alternative is forced through a “gun” to generate puffed cereals.

In addition to the beneficial health aspects of including alpha-cyclodextrin in the ready to eat food product produced in accordance with the above examples, test subjects when sampling the RTE cereal noticed an improvement in the toasted flavor of the grains. It is believed that the alpha-cyclodextrin enhanced or accentuated the toasted grain flavor of the food product as opposed to carrying flavors that may not necessarily be inherent in the product as may have been done with other cyclodextrins in the prior art.

In analyzing the hypocholesterolemic properties, cereal products prepared in connection with the above-mentioned example 1 were then fed to hamsters and the results compared. A control feed, a feed which is principally an oat cereal, an oat cereal in which a portion of the oat flour has been replaced with 3.5% concentration of alpha-cyclodextrin. The results of this study and provided for approximately a 15% reduction in the total cholesterol level as well as the HDL level between the oat cereal and the oat cereal with alpha-cyclodextrin.

The results of the study also provide that the food product of the present invention resulted in a lowering of triglycerides of about ten percent (10%) when compared with the level of triglycerides in the control formula.

In a further example of the present invention a consumable intermediate (dough which is used for making bakery products) was prepared. As provided previously, the intermediate requires further treatment in order to be ready for consumption. Such additional treatment may include but is not limited to cooking, heating, baking, frying, applying radiant energy, etc.

The dough mixture used in forming the dough intermediate was prepared in accordance with the following. The formula is intended to be illustrative only and not limiting in scope of the present invention.

### EXAMPLE 2

| Ingredient | Weight Percentage |
|---|---|
| Flour | 51.8 |
| Water | 23.98 |
| Sugar | 4.03 |
| Corn Syrup | 3.73 |
| Dextrose | 3.51 |
| Yeast | 2.09 |
| Glycerol | 1.86 |
| Shortening | 1.84 |
| Egg Solids | 1.77 |
| Whey | 1.49 |
| Soda | 0.80 |
| Salt | 0.75 |
| SAPP | 0.55 |
| Mono&DI Glycerides | 0.50 |
| Dough Conditioners | 0.50 |
| Flavor | 0.41 |
| SALP | 0.40 |
| Total | 100 |

As used herein SAPP refers to sodium aluminum pyrophosphates, which is a fast acting chemical leavening agent. SALP refers to sodium aluminum phosphate which is slow acting chemical agent. However, other chemical leavening agents may also be used such as DCP—dicalcium phosphate, MCP—monocalcium phosphate monohydrate, SAS—sodium aluminum sulfate, potassium hydrogen tartrate—cream of tartar, combinations and the like.

The flour is preferably a wheat-based flour, but other flour types such as barley, rice, corn, potato and soy flour may also be used in this invention. As in the above examples, a portion of the wheat-based flour is replaced with alpha-cyclodextrin or the ingredients are first processed with an enzyme that produces alpha-cyclodextrin such as cyclodextrin glucosyltransferase, to produce a food intermediate, here a dough, to arrive at the between 0.01 to 25% by weight of the anticipated serving size of the product.

Other components for dough that are useable in the present invention include, for example fat or shortening in an amount from 1 to 20% by weight, egg solids in an amount of from about 0.01% to about 25%, milk replacer, milk solids or whey in an amount of from about 0.1% to about 12%, sugar in an amount from about 1% to about 25%, yeast in an amount of from about 1.0% to about 7% and water in an amount from about 40% to about 80%. The forgoing percentages are based on weight of the mixture.

The dough was prepared by adding the ingredients to a mixer, where it was mixed on low speed for approximately one minute, until a dough ball was formed and then on medium to high speed for approximately eight minutes.

The dough was then removed from the mixture and then sheeted or rolled out and cut into strips. The ends of the strips were moistened with water to form a sealing end for the product. A filling layer, such as cinnamon, fruit filling, cheese, etc. may be deposited onto the dough strips and either encased in the dough or the dough layers simply wrapped on themselves. The dough was then rolled onto itself to form the desired number of rolls, layers or swirls and then the roll is cut into roughly one inch slices to form the dough intermediate.

In a still further example of the present invention potato snacks such as French fries, potato crisps and the like were prepared in a conventional manner and coated with a mixture of starch and alpha-clcyodextrin.

In the present invention French fries (potato strips) is coated or enrobed with a starch matrix consisting of a low amylose corn starch and alpha-cyclodextin. The invention provides an enrobing slurry formed from the combination of low amylose corn starch and alpha-cyclodextrin for coating the outer surface of a potato product

In an exemplary embodiment, Russet potatoes were peeled, cut into roughly quarter inch strips and immersed and blanched in hot water for 5-6 minutes at about 165° F. Next, the potato strips were briefly immersed in an aqueous solution comprising containing about 3% salt and 0.2% SAPP based on total weight of water which was held at a temperature of about 160° F. The potato strips were removed and drained and then dried for about 2-4 minutes in a conventional forced air oven dryer at about 170° F.

Next, the potato strips were then dipped in the starch slurry described above. The potato strips were then drained to remove excess amounts of the slurry resulting in a potato strip product having a coating weight of between 10-20% by weight of the potato strip. The potato strips were par-fried (partially fried) for 30-40 seconds at approximately 350-360° F.

In a still further exemplary embodiment of the present invention, the potato pieces prepared in accordance with the following:

| Ingredient | Percentage | Weight |
|---|---|---|
| Potato | 80% | 3995.2/gm |
| Water | 16.2% | 809.02/gm |
| Salt | 1.5% | 74.91/gm |
| Dent Corn Starch | 0.4% | 19.98/gm |
| Alpha Cyclodextrin | 1.9% | 94.9/gm |
| Total | 100% | |

Each of the ingredients for the exemplary formulation were initially measured out and were added to the water and the solution mixed. In the above example, the mixture will be referred to as the marinade.

A dent corn starch, such as Melojel is a amylose containing food grade starch, derived from corn (approximately 25% amylose) and is available from National Starch of Bridgewater, N.J. The alpha-cyclodextrin is available from Wacker Specialties, Adrian, Mich. 49221 and sold under the trademark CAVAMAX® Wacker-Chemie, Burghausen, Germany.

The salts used herein may be sodium chloride, potassium chloride or mixtures thereof.

The potato pieces are then placed in a tumbler and the marinade added. A vacuum is pulled to a minimum of 22 to about 30 inches with about 25 to 30 inches being preferred. The potato/marinade combination is then tumbled for approximately 30 minutes. After the tumbling periods were complete, the contents of the vessel were emptied and placed in a cooler. The tumbling or marinating time period can range from about 15 minutes to around an hour. Tumbling the marinade and potato under a vacuum, causes the potato/starch complex to act as a sponge thereby permitting the potato to become infused with the marinade.

In other embodiments, the present invention is also useful in treating food products that are provided or sold in an intermediate state so as to be able to reduce acrylamide levels of products that consumers purchase in a par-baked or par-fried condition, that is not fully prepared, and undergo a final baking, frying or cooking in the consumer's home or in a commercial setting such as in a restaurant, cafeteria, etc. That is, the products that are partially prepared or in an intermediate step do not exhibit an elevated level of acrylamide as they have not undergone the final heat treatment step such as cooking or baking. Nonetheless, to inhibit or reduce the amount of acrylamide that may be present in such foods, although at the intermediate step, cyclodextrins are added similarly as that used to make prepared foods or foods in a substantially or completely finished condition. Examples of such products include taco shells, piecrusts, breakfast pastries, biscuits, rolls, bread products, baked goods and the like.

Often and potentially more important than the actual manufacture or delivery of a product is communicating the benefits associated with a particular food product to the consumers. This can be done in a number of ways such as through the preparation of scripted information or indicia that is then released to consumers. The release of such indicia is usually tailored to certain pre-selected or predefined formats and can be done through traditional advertising routes that have at least an audio and or visual capability such as radio, television or over a global computer network as well printed materials. Printed materials may include the packaging into which the product is placed as well as newspapers, letters, direct mail pieces, magazines and the like.

It will thus be seen according to the present invention a highly advantageous food product or food intermediate having reduced acrylamide levels and beneficial hypocholesterolemic properties has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A food product having reduced acrylamide levels after cooking, baking, frying, heating and combinations thereof, comprising;
a food product or food intermediate derived from cereal or vegetable based components or combinations thereof; and
an amount of cyclodextrin ranging from 0.001% to 75% by weight of said food product or food intermediate.

2. A food product as recited in claim 1, wherein said cyclodextrin is selected from a group including alpha-cyclodextrin, beta-cyclodextrin, gamma-cyclodextrin and combinations thereof.

3. A food product as recited in claim 1, wherein said cyclodextrin is a chemically or enzymatically produced derivative of alpha-cyclodextrin, beta-cyclodextrin, gamma-cyclodextrin and combinations thereof.

4. A food product as recited in claim 1, wherein said cyclodextrin is formed in or on the food product by treatment with the enzyme, cyclodextrin glucosyltransferase (CGTase, EC 2.4.1.19) or a mutation or modification thereof.

5. A food product as recited in claim 1, wherein said cyclodextrin is already present in the food by expression of the gene encoding cyclodextrin glucosyltransferase (CGTase, EC 2.4.1.19) or a mutation or modification thereof.

6. A food product as recited in claim 1, wherein said food product also has beneficial hypocholesterolemic properties.

7. A food product as recited in claim 1, wherein said food product is made from dough.

8. A food product as recited in claim 1, wherein said food product is derived at least in part from potatoes.

9. A food product as recited in claim 8, wherein the food product derived from potatoes are potato snacks.

10. A method for producing a food product having a reduced acrylamide levels after heating, baking, cooking, frying and combinations thereof, comprising the steps of;
providing one or more ingredients useful in forming a food product;
adding to said one or more ingredients an amount of cyclodextrin;
producing said food product containing said amount of cyclodextrin; and
distributing said food product.

11. A method as recited in claim 10, wherein said amount of cyclodextrin is selected from a group including alpha-cyclodextrin, beta-cyclodextrin, gamma-cyclodextrin and combinations thereof.

12. A method as recited in claim 10, wherein said amount of cyclodextrin ranges from 0.01 to 75% by weight of said food product.

13. A method as recited in claim 10, wherein said one or more ingredients includes a grain.

14. A method as recited in claim 10, wherein said one or more ingredients includes a vegetable.

15. A method as recited in claim 14, wherein said vegetable is a potato.

16. A method of communicating a beneficial effect of a food product having reduced acrylamide levels, comprising the steps of;
providing a food product having an amount of cyclodextrin;
packaging said food product;
producing a message relating to said food product and its reduced acrylamide levels;
distributing said food product to consumers for consumption; and
communicating said message.

17. A method of communicating a beneficial effect as recited in claim 16, wherein said amount of cyclodextrin ranges from 0.01 to 75% by weight of said food product.

18. A method of communicating a beneficial effect as recited in claim 16, wherein the step of communication the message is accomplished through at television, radio, printed communications, over a global computer network and combinations thereof.

19. A vegetable or cereal based food product or food intermediate having reduced acrylamide levels after baking, heating, cooking, frying and combinations thereof and containing between 0.01 to 75% by weight of a cyclodextrin.
